(19) United States
(12) Patent Application Publication
(10) Pub. No.: US 2026/0200553 A1
(43) Pub. Date: Jul. 16, 2026

(54) CHOCK COVER ON VESSEL AND METHOD FOR MANUFACTURING THEREOF

(71) Applicants: Yong Ha PARK, Geoje-si (KR); MIR ENG CO., LTD, Busan (KR)

(72) Inventors: Yong Ha PARK, Geoje-si (KR); Gyu Sug KIM, Busan (KR)

(21) Appl. No.: 19/118,397

(22) PCT Filed: Oct. 5, 2023
(86) PCT No.: PCT/KR2023/015294

§ 371 Date: Apr. 3, 2026

(30) Foreign Application Priority Data
Oct. 7, 2022 (KR) 10-2022-0128990
Oct. 25, 2022 (KR) 10-2022-0138746

(51) Int. Cl. B63B 21/20; B29C 70/08; B29C 70/44; B29K 63/00; B29K 307/04; B29K 309/08; B29L 31/30

(52) U.S. Cl. CPC B63B 21/20; B29C 70/08; B29C 70/44; B29K 2063/00; B29K 2307/04; B29K 2309/08; B29L 2031/3067

(57) ABSTRACT

The present invention relates to a chock cover on a vessel and a manufacturing method thereof. Disclosed are the chock cover on a vessel and the manufacturing method therefor, the chock cover being formed through lamination of two or more different prepregs in which a resin comprising at least one of epoxy, phenol and high-density polyethylene (HDPE) is impregnated into a fiber comprising at least one of glass, carbon and aramid fiber, and being bent outward with a predetermined curvature along an inner central axis, wherein the laminated prepregs are divided into three or more pieces.

### TECHNICAL FIELD

The present invention relates to a chock cover on a vessel and a manufacturing method thereof, and more specifically, to a chock cover minimizing friction with a rope and a manufacturing method thereof. In addition, the present invention relates to a chock cover minimizing a portion where a rope is bent.

### Background Art

In general, when loading and unloading cargo during operation of a vessel, repairing the vessel irregularly or regularly, or anchoring the vessel at a mooring, the vessel is secured by connecting ropes to secure the vessel. The rope connects the vessel and the berth, and is subject to a lot of load. In that case, the mooring fairlead, also known as chock, is what secures and guides the rope on the vessel. The chock is made of cast steel, which has higher elongation and tensile strength than cast iron, and is usually located on the deck of a vessel or inside the vessel.

Meanwhile, the rope that comes into contact with the chock is made of nylon, and thus, depending on the strength of the wind or waves at the anchorage of the vessel, the rope, which is relatively weaker than the chock, may be pressed or worn. If the rope is damaged and breaks, it can cause damage to people and equipment in the vicinity due to its strong tensile force.

In order to prevent these, a method of installing a protective cover on the rope has been proposed, but its effectiveness has been questioned. Alternatively, when installing a protective cover on the chock, it has been suggested to make the curvature radius of the rope larger than a certain size to minimize the bending portion and to make the material of the protective cover similar to minimize wear and friction. However, if the curvature radius of the chock is made large, the size is limited due to the special characteristic of the vessel and marine structures.

In the conventional technology, a technology is used to prevent direct friction by installing a plastic chock liner, but it is heavy and divided into two parts, and thus, it is difficult to fasten, and there is a risk of work during installation. In addition, there are disadvantages that it is expensive, has the problem of being large and difficult to handle, and thus the entire chock liner must be replaced when damaged.

Therefore, there is a need to develop a chock cover that is easy to handle and inexpensive, while minimizing damage and wear to the rope and lowering the risk of injury during replacement.

In addition, the chock made of cast steel does not have a smooth surface and is uneven due to the nature of cast steel, and thus, a gap may be created between the chock covers when they are installed. There was a risk that the chock cover would break due to the rope being subject to a large load while connecting the vessel and the anchorage, and there was a problem that the rope's life would be shortened as its breaking strength was reduced due to repeated bending of the rope.

Therefore, there is a need for a technology that can prevent damage to the chock cover due to the load of the rope and shorten the service life due to repeated bending of the rope.

### DISCLOSURE

### Technical Problem

It is an object of the present invention to solve the above-mentioned problems and other problems. It is another object to provide a chock cover that minimizes friction with a rope.

It is another object to provide a chock cover that minimizes a portion where a rope is bent.

### Technical Solution

In order to achieve the above or other objects, according to one aspect of the present invention, there is provided a chock cover on a vessel, which is formed by laminating two or more different prepregs formed by impregnating a resin containing one or more of epoxy, phenol and high density polyethylene (HDPE) into a fiber containing one or more of glass, carbon and aramid fibers, and is bent outwardly with a predetermined curvature along an inner central axis, wherein the laminated prepregs are divided and formed into three or more pieces, and a method for manufacturing the same.

According to one aspect of the present invention, the chock cover is divided and formed into three pieces, first to third pieces, while wrapping around the chock, and the first to third pieces can have a width that can vary along an inner central axis of the chock cover.

According to one aspect of the present invention, the chock cover is divided and formed of four pieces, first to fourth pieces, while wrapping the chock, and the first and second pieces may have varying widths while being formed to face the third and fourth pieces, respectively.

According to one aspect of the present invention, the first and second pieces may be symmetrical with the third and fourth pieces, respectively, about an inner central axis of the chock cover.

According to one aspect of the present invention, the first and third pieces may have a shape that is narrow at the top and wide at the bottom, and the second and fourth pieces may have a shape that is wide at the top and narrow at the bottom.

According to one aspect of the present invention, the present invention provides the method for manufacturing the chock cover that protects a rope secured and guided by a chock on a vessel from the chock, the method comprising the steps of: (a) impregnating fibers with a resin to form a first prepreg; (b) impregnating fibers with a resin to form a second prepreg; (c) laminating the first prepreg and the second prepreg; and (d) molding the laminated prepregs in an oven and an autoclave, wherein the first prepreg and the second prepreg are different from each other in at least one of the components, contents and thicknesses, and wherein the prepreg may include a fiber base including at least one of glass fibers, carbon fibers, and aramid fibers, and a resin including at least one of epoxy, phenol, and high density polyethylene (HDPE).

According to one aspect of the present invention, the molding step may comprise a step of removing volatile components from the laminated prepregs in a vacuum bag; a step of heating the prepregs in an oven and autoclave at 100 to 180° C.; and a step of applying a pressure of 1 to 7 bar while heating in the autoclave.

According to one aspect of the present invention, the method of the present invention further includes a step of mixing an additive after forming the first and second prepregs, wherein at least one of carbon nanotubes and graphite may be added in an amount of 0.5 to 2 wt. % as the additive.

According to one aspect of the present invention, the prepregs may be composed of three or more layers, and when the prepregs include only one type of fiber, they may be laminated in an order such that their thickness gradually decreases from the lower layer to the upper layer.

According to one aspect of the present invention, the prepregs may be composed of three or more layers, and when the prepregs include two or more types of fibers, the prepregs may be laminated so that thinner prepregs are positioned at the bottom and top layers, and thicker prepregs are positioned inside.

Also, in order to achieve the above or other objects, the present invention provides a chock cover on a vessel, which comprises a hollow composite material having an outer surface in contact with a rope; and a rubber member attached to at least a portion of the inner surface of the composite material and in contact with the outer surface of the chock.

According to one aspect of the present invention, the composite material includes a front portion facing the outside of the vessel and a rear portion facing the vessel, and the rubber member may have a radius of curvature that increases toward the front portion.

According to one aspect of the present invention, the ratio of the diameter (d) of the rope to the diameter (D) of the chock cover, D/d, may be 15 or more.

According to one aspect of the present invention, the composite material may be formed by laminating two or more different prepregs formed by impregnating a resin containing one or more of epoxy, phenol and high-density polyethylene (HDPE) into a fiber containing one or more of glass, carbon and aramid fibers, and bent outwardly with a predetermined curvature along an inner central axis.

According to one aspect of the present invention, the composite material is divided and formed into three pieces, first to third pieces, while wrapping around the chock, and the first to third pieces can have a width that can vary along an inner central axis of the chock cover.

According to one aspect of the present invention, the composite material is divided and formed into four pieces, first to fourth pieces, while wrapping the chock, and the first to fourth pieces can have a width that can vary along an inner central axis of the chock cover.

### ADVANTAGEOUS EFFECTS

The chock cover on a vessel according to the present invention and its manufacturing method are described as follows.

According to at least one of the embodiments of the present invention, there is an advantage in that damage caused by friction of the rope can be minimized by the additive.

According to at least one of the embodiments of the present invention, it has the advantage of being able to withstand high loads from ropes by minimizing internal pores through molding.

According to at least one of the embodiments of the present invention, the delamination of laminates at the interface can be minimized according to the lamination method of the present invention.

According to at least one of the embodiments of the present invention, there is an advantage in that a strong load caused by a rope can be dispersed by attaching a rubber member between the chock and the chock cover.

According to at least one of the embodiments of the present invention, by increasing the radius of curvature of the chock cover, the phenomenon of shortening the life of the rope due to repeated bending of the rope can be prevented.

According to at least one of the embodiments of the present invention, by manufacturing the chock cover with a uniform thickness and varying the thickness of the rubber member attached between the chock and the chock cover, there is an advantage in that the chock cover can be prevented from peeling off, the manufacturing cost can be reduced, and the weight can be reduced.

Further scope of applicability of the present invention will become apparent from the detailed description below. However, since various changes and modifications within the spirit and scope of the present invention will become apparent to those skilled in the art, it should be understood that the detailed description and specific embodiments, such as preferred embodiments of the present invention, are given by way of example only.

### DESCRIPTION OF DRAWINGS

FIG. 1 is a flow chart of a manufacturing process of a chock cover on a vessel according to one embodiment of the present invention.

FIG. 2 is an exploded perspective view of a four-part chock cover according to one embodiment of the present invention.

FIG. 3 is a front view of a four-part chock cover according to one embodiment of the present invention.

FIG. 4 is a rear view of a four-part chock cover according to one embodiment of the present invention.

FIG. 5 is an exploded perspective view of a three-part chock cover according to one embodiment of the present invention.

FIG. 6A is a rear view of a three-part chock cover according to one embodiment of the present invention, and FIG. 6B is a front view of a three-part chock cover according to one embodiment of the present invention.

FIG. 7 is a cross-sectional view of a connection method of a chock cover according to one embodiment of the present invention.

FIG. 8 is a cross-sectional view of a single fiber resin composite material according to one embodiment of the present invention.

FIGS. 9A through 9C are cross-sectional views of composite fiber resin composite materials according to one embodiment of the present invention.

FIG. 10 is a cross-sectional view illustrating a state in which a chock cover is attached to a chock, according to one embodiment of the present invention.

FIG. 11 is a cross-sectional view showing the ratio of the diameter of the chock curvature to the diameter of the rope, according to one embodiment of the present invention.

FIG. 12 is a plan view showing the front portion of a three-part chock cover according to one embodiment of the present invention.

FIG. 13 is an exploded perspective view of a three-part chock cover according to one embodiment of the present invention.

FIG. 14 is a plan view showing the front portion of a four-part chock cover according to one embodiment of the present invention.

FIG. 15 is a perspective view of a chock cover connected to a chock according to one embodiment of the present invention.

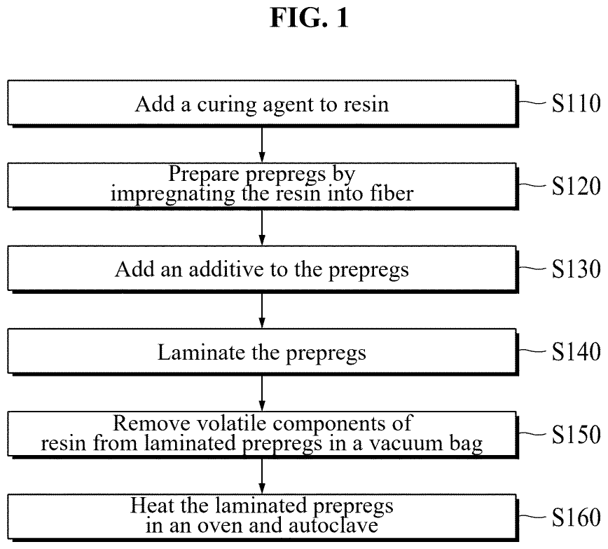

### BEST MODE

Hereinafter, the embodiments disclosed in this specification will be described in detail with reference to the attached drawings, wherein regardless of the drawing symbols, the same or similar components will be given the same reference numerals and redundant descriptions thereof will be omitted. The suffix “portion” for components used in the following description is given or used interchangeably only for the sake of ease of writing the specification, and does not in itself have a distinct meaning or role. In addition, when describing the embodiments disclosed in this specification, if it is determined that a detailed description of a related known technology may obscure the gist of the embodiments disclosed in this specification, the detailed description thereof will be omitted. In addition, the accompanying drawings are only intended to facilitate easy understanding of the embodiments disclosed in the present specification, and the technical ideas disclosed in the present specification are not limited by the accompanying drawings, but should be understood to include all modifications, equivalents, or alternatives included in the spirit and technical scope of the present invention. Terms that include ordinal numbers, such as first, second, etc., may be used to describe various components, but the components are not limited by the terms. The terms are used only to distinguish one component from another.

The word “a” or “an” includes plural expressions unless the context clearly indicates otherwise.

As used herein, the terms “comprise” or “has” should be understood to specify the presence of a feature, number, step, operation, component, part, or combination thereof described in the specification, but not to exclude in advance the possibility of the presence or addition of one or more other features, numbers, steps, operations, components, parts, or combinations thereof.

The present invention relates to a chock cover 100, 200 on a vessel, and more particularly, to a chock cover 100, 200 that minimizes friction with a rope. In one embodiment of the present invention, an efficient manufacturing process for a chock cover 100, 200 for minimizing friction with a rope and an effect according to the configuration of a completed chock cover 100, 200 are described.

Hereinafter, embodiments of the present invention will be described with reference to the accompanying drawings.

In one embodiment of the present invention, in selecting fibers that occupy the largest portion of the volume of the composite and thus transmit the greatest load, specific gravity, tensile strength and tensile stiffness, compressive strength and compressive stiffness, fatigue strength and fatigue fracture mechanism, electrical and thermal conductivity, and price were considered, and thus suitable glass fibers, carbon fibers, and aramid fibers were used.

Glass fiber has been widely used in the marine field since the 1940s, and it is inexpensive, but has high tensile strength, chemical resistance, and excellent insulation properties. In addition, although the static strength increases as the content of glass fiber increases, there is a disadvantage in that the tensile strength frequently decreases due to sensitivity to wear, and wear occurs in the forming die and cutting tool due to relatively low fatigue resistance and high hardness.

Carbon fiber is a fiber composed of more than 90% carbon atoms, and it is a material that combines the structural, organizational characteristics, and morphological characteristics of the carbon material of the constituent elements. Carbon fiber is 5 times lighter than steel, but 10 times stronger, has a tensile strength 10 to 20 times higher than that of nylon, and has excellent properties such as heat resistance, chemical stability, and dimensional stability due to low thermal expansion, and has excellent adsorption characteristics depending on the activation conditions.

Aramid fiber is a material that is lighter and stronger than steel, and because it has a high elastic modulus due to its low specific gravity, excellent thermal stability, fire resistance, and low electrical conductivity, it is widely used as a reinforcing material for polymer composite materials. In addition, the aramid fiber has the advantages of excellent specific strength and wear resistance, and is largely classified into meta-aramid and para-aramid. In one embodiment of the present invention, a fiber-reinforced composite material was manufactured using the para-aramid fiber, which has high strength and rigidity, maintains mechanical properties even at high temperatures, and is less susceptible to heat deterioration.

The resin, which acts as a matrix for fiber-reinforced composite materials, transmits stress between fibers, protects the fibers from adverse environments, and at the same time, protects the fibers from wear. The matrix does not play a significant role in the transmission of tensile forces in composite structures, but it plays a very important role in the shear properties in the plane or the interlaminar shear properties. When designing a structure subjected to bending, the interlaminar shear strength should be considered as an important factor, and when designing a structure subjected to torsional load, the shear strength should be considered as an important factor.

In particular, the matrix suppresses the buckling phenomenon of the fibers to a certain extent when compressive stress occurs, and also contributes to improving the compressive strength of the composite material. The interaction between the fibers and the matrix is an important factor in damage-tolerance structural design, and the processability and internal defects of the composite material are closely related to the viscosity, melting temperature, and curing temperature of the matrix.

In selecting the matrix, phenol, high density polyethylene (HDPE), epoxy, etc. can be used. In one embodiment of the present invention, epoxy having an epoxide structure was used as the matrix of the fiber-reinforced composite material. Although it has the disadvantage of being expensive, it has various advantages in properties such as adhesion to fibers, chemical shrinkage, heat and chemical properties, creep, and fatigue.

Epoxy resin is rarely used alone, but is mixed with a curing agent to harden into a thermosetting material, and its performance is greatly affected by the selection of the curing agent. Therefore, in one embodiment of the present invention, a curing agent was used to lower the solubility and harden.

The curing agent can be a bisphenol type, novolac type, aromatic amine type, alicyclic type, etc., which are potential curing agents. In order to improve the efficiency of the work, dicyan-diamide, a potential curing agent, is mixed into the epoxy resin at an equivalent ratio of 20 to 80% to harden the matrix and maintain a high viscosity.

The matrix is impregnated with one or more fibers selected from the glass fibers, carbon fibers and aramid fibers to produce a prepreg in the form of a sheet. At this time, the matrix can be produced by mixing one or more of the glass fibers, carbon fibers and aramid fibers. That is, each of the glass fibers, carbon fibers and aramid fibers can be used as the matrix, or two or three of them can be mixed to produce the prepreg.

The prepreg can be manufactured using hand lay-up method, compression molding, vacuum bag molding, etc. In one embodiment of the present invention, the prepreg was manufactured using vacuum bag molding.

In addition, carbon nanotubes or graphite can be used as additives during the manufacture of the prepreg.

Carbon nanotubes have a perfect crystal structure in which the bonding force between carbons is maximized, and thus have the characteristics of high rigidity and high strength even at a low specific gravity. Therefore, by adding carbon nanotubes to the resin, thermal conductivity or electrical conductivity resin impregnation can be controlled. As the amount of carbon nanotubes increases, the wear characteristics improve. In addition, since the load is well transmitted through the surface of the carbon nanotubes by adding carbon nanotubes, wear can be reduced compared to pure epoxy that does not contain carbon nanotube reinforcement.

That is, the functional group introduced to the surface of the carbon nanotube increases the bonding strength with the polymer resin, facilitates its dispersion within the polymer, and a smooth and narrow wear surface is found compared to pure epoxy which creates many deep scratches. As a result, the carbon nanotube located near the surface forms a thin carbon film, which acts as a lubricating film to reduce friction, thereby resulting in the effect of reducing friction with the rope.

In one embodiment of the present invention, the additive is added in an amount of 0.1 to 5 wt. % of the total weight during mixing. If the additive is mixed in an amount of less than 0.1 wt. %, a pulling phenomenon may occur and thus the additive may not be well combined with the epoxy base, and if it exceeds 5 wt. %, the additive may be dispersed and coagulation may not occur well.

The prepregs containing the additive are laminated as follows.

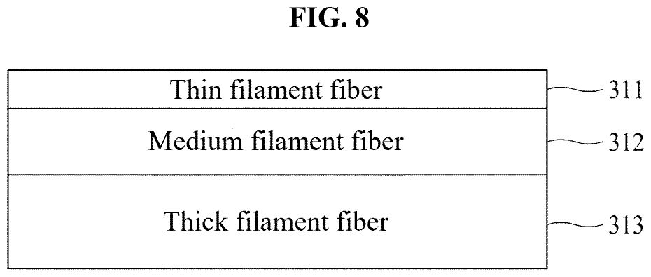

The laminate of the composite material is composed of a single fiber resin composite and a mixed fiber resin composite. In the case of a single fiber resin composite, in one embodiment of the present invention, glass fiber, carbon fiber, and aramid fiber are laminated by the lamination method illustrated in FIG. 8. That is, FIG. 8 is a cross-sectional view of a single fiber resin composite according to one embodiment of the present invention. When the prepregs include only one type of fiber, they are laminated in an order such that their thickness gradually decreases from the lower layer to the upper layer.

More specifically, in order to make the thermal expansion rate uniform during lamination of a plurality of prepregs, a thick fiber prepreg sheet 313, a medium fiber prepreg sheet 312, and a thin fiber prepreg sheet 311 are laminated in order from bottom to top according to thickness. In the completed single fiber resin composite, the thick fiber prepreg sheet 313 becomes a portion that comes into contact with the chock, and the thin fiber prepreg sheet 311 is exposed to the outside to come into contact with the rope.

The thin fiber prepreg sheet 311 may have a thickness of 0.01 to 0.2 mm, the medium fiber prepreg sheet 312 may have a thickness of 0.2 to 0.8 mm, and the thick fiber prepreg sheet 313 may have a thickness of 0.8 to 5.0 mm.

The above prepreg sheet varies in strength, stiffness and various other characteristics depending on the lamination angle, the number of repeated laminations and the total number of prepregs. In one embodiment of the present invention, when the direction in which the fibers advance in the prepreg during lamination is set to 0°, the prepregs of each orientation angle are laminated with the direction perpendicular thereto set to 90° based on 0°. After laminating the prepregs with different orientation angles of 45° clockwise and 45° counterclockwise (hereinafter −45° ) based on 0°, in the case of a thin prepreg, lamination is repeated twice in the order of one 0° prepreg, one −45° prepreg, one 45° prepreg, and one 90° prepreg from the bottom to the top so that the top always has an orientation angle of 90°.

In the case of the thin fiber prepreg 311 in contact with the rope, since it has a low surface roughness, friction with the rope can be reduced, thereby minimizing damage to the rope. In addition, when laminating in the order of the orientation angles, the load is distributed, thereby reducing bending, and thus minimizing deformation.

In addition, the medium fiber prepreg 312 was laminated twice in the same order as the thin prepreg 311, and the thick fiber prepreg 313 was laminated 20 times in the same order as the thin prepreg. In another embodiment of the present invention, a prepreg can be formed by laminating at a lamination angle and a number of lamination repetitions different from the above conditions.

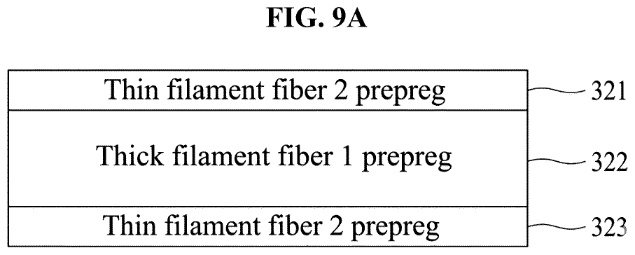

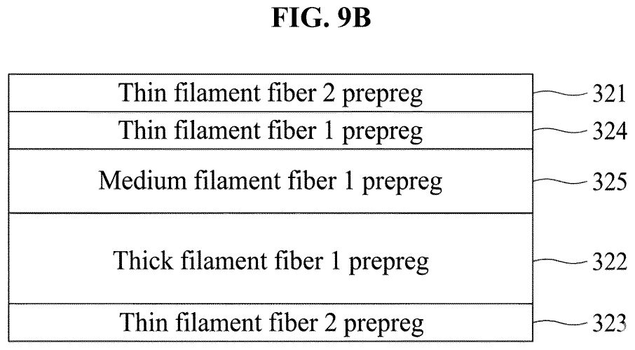

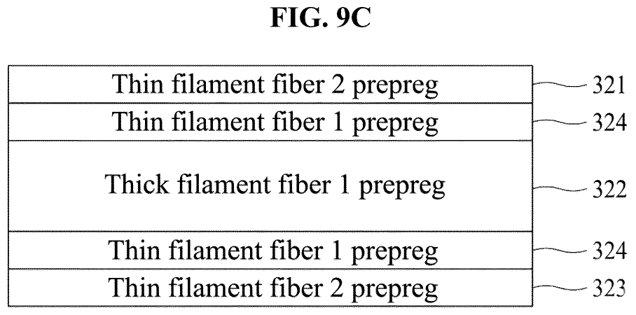

Next, a mixed fiber resin composite in which two or more types of fiber resin prepregs are laminated is illustrated in FIG. 9. FIG. 9 is a cross-sectional view of a composite fiber resin composite according to an embodiment of the present invention. Referring to FIG. 9, when the prepreg contains two or more types of fibers, the prepregs are laminated internally so that thin fiber prepregs 321, 323 are positioned at the bottom and top layers, and thicker fiber prepregs 322 are positioned internally. For example, in the case of the mixed fiber resin composite, the matrix material, like the single fiber resin composite, uses glass fiber, carbon fiber, and aramid fiber, and as in FIG. 9A, a thick fiber prepreg 322 is placed in the middle, and thin fiber prepregs 321, 323 can be laminated to the upper and lower layers, respectively. In addition, as in FIG. 9B, five mixed fiber resin prepregs are manufactured and laminated. Thin fiber prepregs 321, 323 are positioned on the outermost top layer and the bottommost layer, a medium prepreg 325 is laminated on the middle layer, and a thin fiber prepreg 324 and a thick fiber prepreg 322 can be laminated between the middle layer and the outermost layer. Furthermore, in the case of laminating the prepreg in five layers as in FIG. 9C, a thin fiber prepreg 321, 323 may be positioned on the outermost top layer and the bottom layer, a thick fiber prepreg 322 may be laminated on the middle layer, and a thin fiber prepreg 324 different from the prepreg of the outermost layer may be laminated between the middle layer and the outermost layer.

The lamination order of the mixed fiber resin composite can be lamination in the same orientation angle order as the single fiber resin composite, and it is preferable to laminate carbon and aramid fiber prepregs for the outermost top layer and bottom layer. When molding glass-based fibers alone, there are problems that the thinner the thickness, the more likely it is that distortion will occur in the molded product, and the glass-based fibers may wear out the rope due to the resin that may soften when absorbing moisture. These problems can be solved by laminating carbon and aramid fiber prepregs that are resistant to ultraviolet abrasion as the outermost layer, thereby suppressing distortion and minimizing delamination at the interface between prepregs of different materials.

Next, the laminated single fiber resin composite material and the mixed fiber resin composite material are molded using an oven and an autoclave.

After laminating the above single fiber resin composite material and the mixed fiber resin composite material, the outside of the vacuum bag is maintained under gas pressure and the inside is maintained under vacuum by a pump in a vacuum bag, and thus the volatile components of the resin inside the composite material are removed, and then the composite material is heated at 100 to 180° C. while maintaining a vacuum in an oven or autoclave to be molded. However, in the case of an autoclave, since a pressure of 3 to 7 bar is applied during molding, a product having a denser structure can be made.

Under the above molding conditions, the temperature of the oven is preferably 120 to 130° C., and the temperature of the autoclave is preferably 120 to 130° C. at 4 to 5 bar. Under the above conditions, the internal pores of the composite material can be minimized, the composite material can withstand a high load from the rope, and the surface can be made smooth to minimize friction.

Meanwhile, the shape of the chock cover manufactured through a manufacturing process according to one embodiment of the present invention may be configured as three-part or four-part. The four-part chock cover may be named the first embodiment, and the three-part chock cover may be named the second embodiment.

The chock cover on a vessel according to one embodiment of the present invention is formed by laminating two or more different prepregs in which a resin including at least one of epoxy, phenol, and high density polyethylene (HDPE) is impregnated into fibers including at least one of glass, carbon, and aramid fibers, which is bent outwardly in a predetermined curvature in the (a) and (b) directions along an inner central axis C1, C2, wherein the prepreg formed by the lamination is divided and formed into three or more pieces.

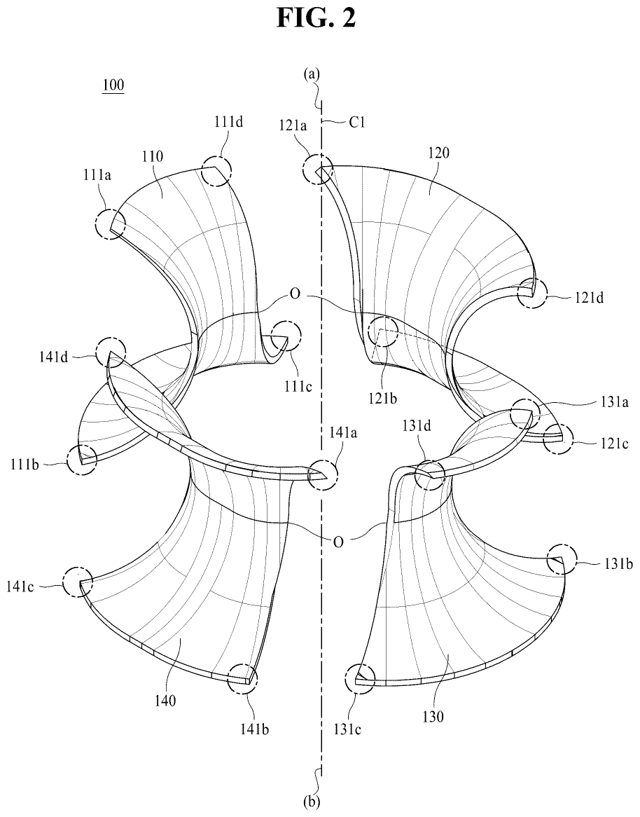

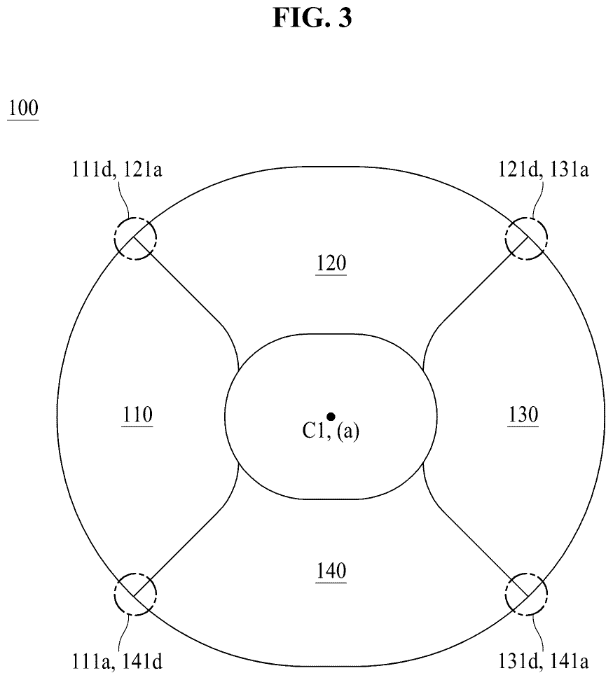

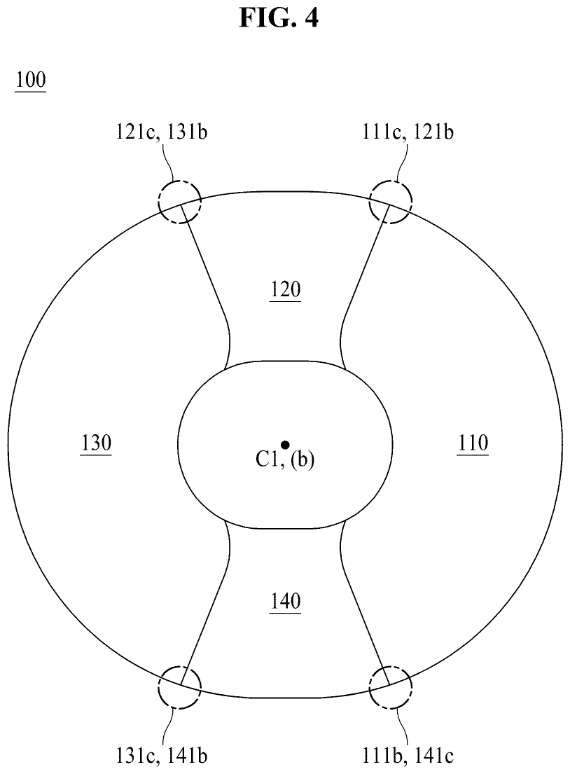

FIG. 2 is an exploded perspective view of a four-part chock cover 100 related to one embodiment of the present invention, FIG. 3 is a front view of the four-part chock cover 100, and FIG. 4 is a rear view of the four-part chock cover 100. Hereinafter, the four-part chock cover 100 will be described with reference to FIGS. 2 to 4. In one embodiment of the present invention, the front side means a side facing the outside (the sea) when the chock cover is installed on the vessel, and the rear side means a side facing the vessel when the chock cover is installed on the vessel.

As illustrated in FIGS. 2 to 4, the four-part chock cover 100 according to the first embodiment of the present invention is divided and formed into four pieces, first to fourth pieces 110, 120, 130, 140, while wrapping the chock. The first piece 110 and the second piece 120 are formed to face the third piece 130 and the fourth piece 140, respectively, and are formed so that their widths change. In this case, the first piece 110 and the third piece 130 have a shape that is narrow at the top and wide at the bottom along the central axis C, and the second piece 120 and the fourth piece 140 have a shape that is wide at the top and narrow at the bottom along the central axis C.

The shape of the inside of the chock into which the chock cover of the four-part chock cover 100 is assembled may be formed so that the front (a) direction is wide along the central axis C1 and the rear (b) direction is narrow, and thus the chock cover of the four-part chock cover 100 may also be formed so that the first to fourth pieces 110, 120, 130, 140 are wide in the front (a) direction and narrow in the rear (b) direction along the central axis C1. This is to maximize the curvature radius of the front portion that comes into direct contact with the rope, thereby also maximize the curvature radius of the rope that is bent.

In addition, the internal shape of the chock may be oval or circular when viewed from the front as illustrated in FIG. 3, and the central axis C1 may be oval or circular and is formed in the diametric direction and the vertical direction (a-b).

In the four-part chock cover 100 composed of the first to fourth pieces 110, 120, 130, 140 illustrated in FIG. 2, the chock covers of the first to fourth pieces 110, 120, 130, 140 are in contact with each other through the interfaces on both sides, and when assembled along each interface, the front side has the shape shown in FIG. 3 and the rear side has the shape shown in FIG. 4. In this case, the radius of the front side of the chock cover 100 can be made larger than the radius size of the rear side.

In the first to fourth pieces 110, 120, 130, 140 illustrated in FIG. 2, the first piece 110 and the third piece 130, and the second piece 120 and the fourth piece 140 are formed with different widths at the front and back with predetermined curvatures, and thus have structures in which they are intertwined with each other, so that when a load of a rope is applied to the chock cover of some pieces, the force is distributed to the remaining pieces due to the structure in which the adjacent pieces also receive force from each other. The interfaces 111a-111b, 111c-111d, 121a-121b, 121c-121d, 131a-131b, 131c-131d, 141a-141b, 141c-141d of the first to fourth pieces 110, 120, 130, 140 may have a spiral shape twisted along the central axis C1.

This can prevent the phenomenon in which the load of the rope is concentrated on only some pieces by forming the width of the first to fourth pieces 110, 120, 130, 140 into four equal parts with the same size from the front and back, and thus can prevent problems such as deterioration of specific pieces and cracks easily occurring in the joints of pieces.

In these cases, the part of the chock cover 100 where the rope comes into contact and comes out to the outside is preferably formed as a wide part without a seam, i.e., a fourth piece 140, as shown in FIG. 3, at the lower part of the front where the rope touches due to gravity, in order to prevent friction of the rope that bears a large load at the seam portion of the piece, i.e., part where the interface of 141a-141b and the interface of 131d-131c of FIG. 2 touch and the part where the interface of 141d-141c and the interface of 111a-111b touch, as much as possible. Instead of the fourth piece 140, it can also be formed as a second piece 120.

Meanwhile, the chock cover is divided and formed into three pieces, first to third pieces 210, 220, 230, while wrapping the chock, and the widths of the first to third pieces 210, 220, 230 can be changed in the (a) direction and the (b) direction along an inner central axis C2 of the chock cover.

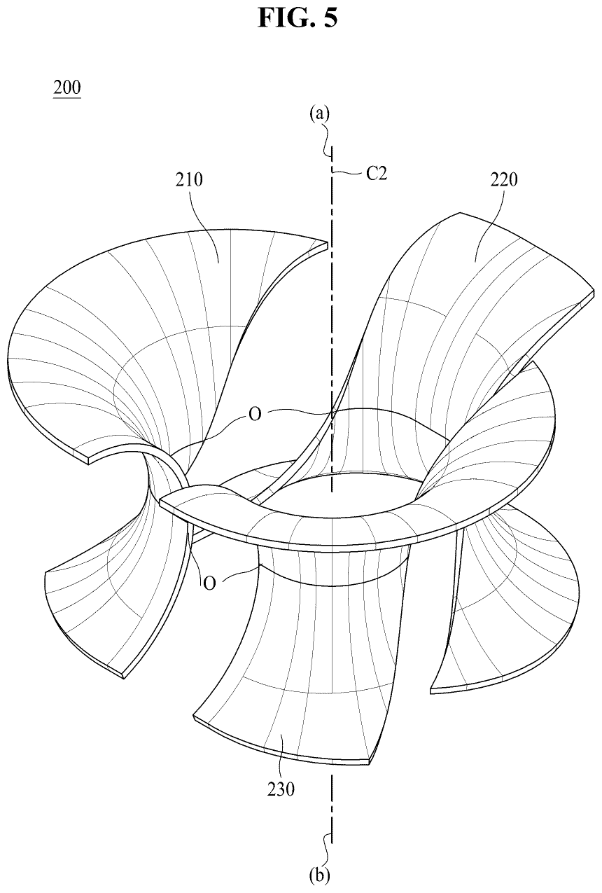

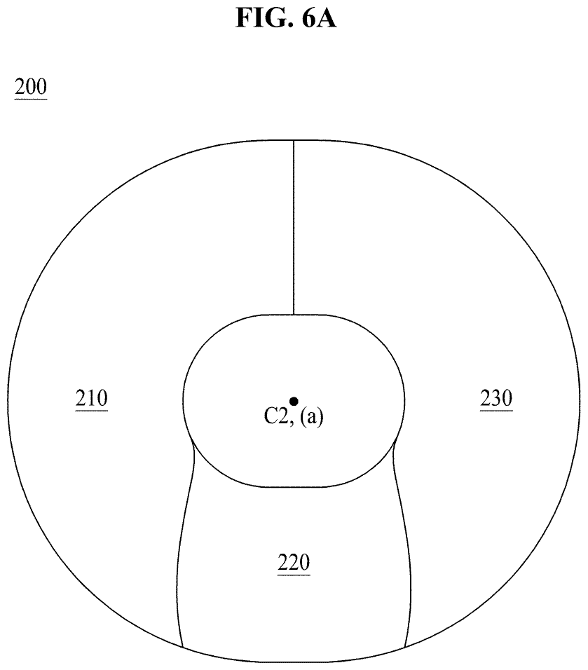

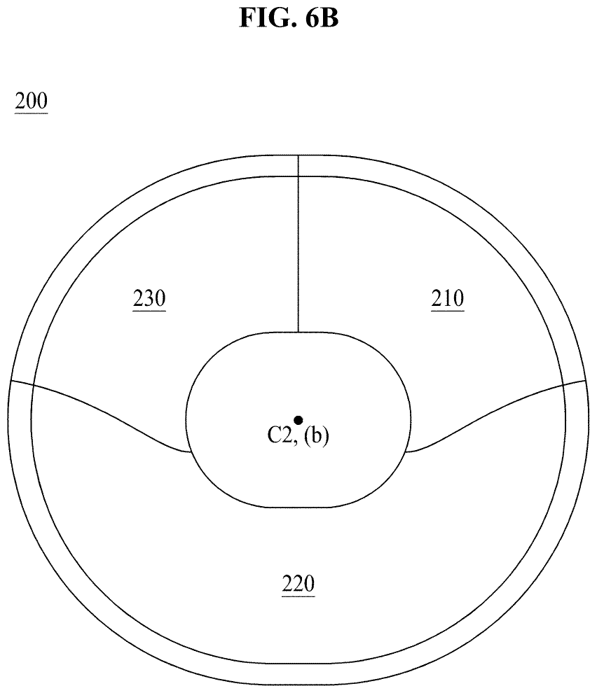

FIG. 5 is an exploded perspective view of a three-part chock cover 200 according to one embodiment of the present invention, and FIG. 6A is a view of the three-part chock cover 200 as viewed from the rear, and FIG. 6B is a view of the three-part chock cover 200 as viewed from the front.

Hereinafter, the description is given with reference to FIG. 5, FIG. 6A, and FIG. 6B.

The 3-part chock cover 200 illustrated in FIG. 5, FIG. 6A, and FIG. 6B also applies the same principle as the 4-part chock cover 100, so that the load of the rope borne by one chock cover is evenly distributed to the remaining chock covers, and the chock covers with different widths play a role in holding and supporting each other, thereby adding sturdiness. In order to reduce friction caused by the rope at the interface where the first to third pieces 210, 220, 230 are in contact, it is preferable to position the first piece 220 in a shape that is wide at the top and narrow at the bottom at the lower end in the front (b) direction along the central axis C2 as shown in FIG. 6B.

In addition, a dye may be added in the step of mixing the resin with a curing agent to color each of the four-and three-part pieces. when curing, it is desirable to use a coloring agent such as a pigment that does not affect the properties of the resin, and in order to distinguish each piece, for example, in the case of a four-part division, the pieces facing each other can be made with the same color, and the pieces touching each other can be manufactured with a different color, and in order to easily distinguish multiple chocks within a vessel, they can be applied in various colors.

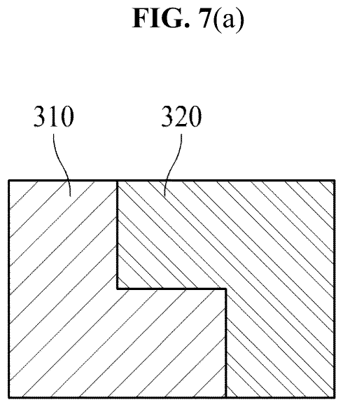

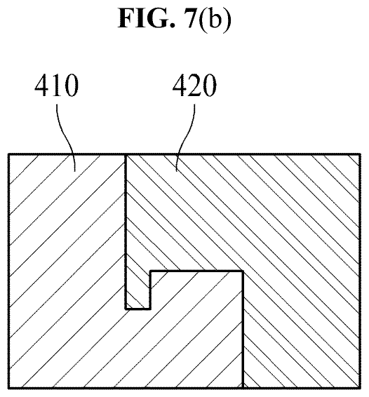

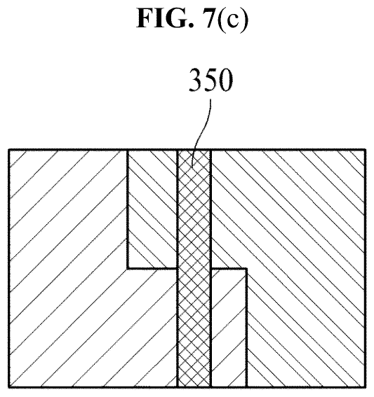

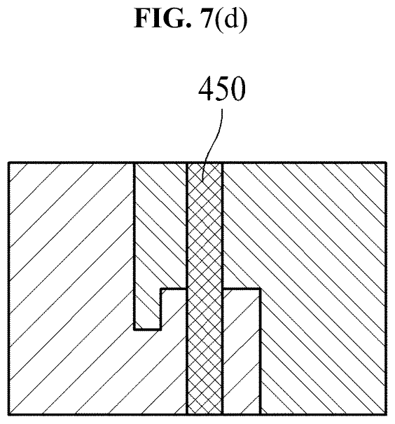

The mutual fastening of the above three-or four-part chock covers can be mounted in an ‘L’ shape 310, 320 in an alternating manner as shown in FIG. 7A, or accomplished by fastening bolts 350 in the vertical direction when combined as shown in FIG. 7C, or by fixing them with an adhesive.

In addition, they can be fitted with a method of bonding the gaps to minimize moisture and foreign matter penetration between the gaps, as shown in FIG. 7B, and fastened by bolts 450 or secured with adhesive after fastening.

### EXAMPLE

(a) Prepare a matrix by mixing epoxy resin with a curing agent at an equivalent ratio of 20 to 80%.
(b) Prepare the prepreg by impregnating the matrix into glass fiber and carbon fiber respectively.
(c) Add 0.1 to 5 wt. % of carbon nanotubes to each of the above prepregs.
(d) Place the glass fiber prepreg in the center and laminate the carbon fiber prepreg on the upper and lower layers.
(e) Remove volatile components of resin from laminated prepregs in a 1 bar vacuum bag.
(f) After working in a vacuum bag, mold the laminated prepregs in an autoclave at 3 to 7 bar and 100 to 180° C.

Meanwhile, the present invention relates to a chock cover 500 on a vessel, and more specifically, to a chock cover 500 that minimizes the portion where a rope 40 is bent. In the present invention, the configuration of a chock cover 500 for minimizing the bending portion of a rope 40 and the effect of a completed chock cover 500 are described.

Hereinafter, an embodiment of the present invention will be described with reference to the accompanying drawings.

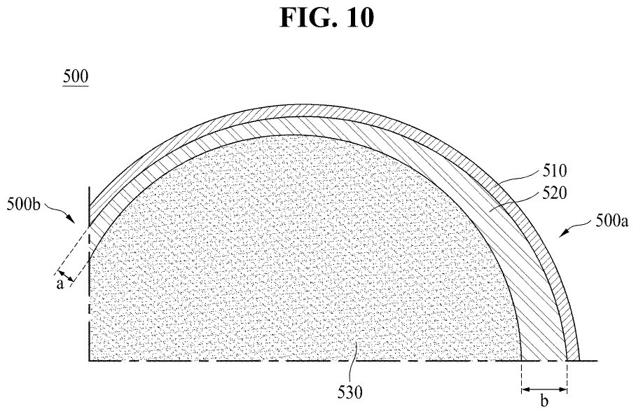

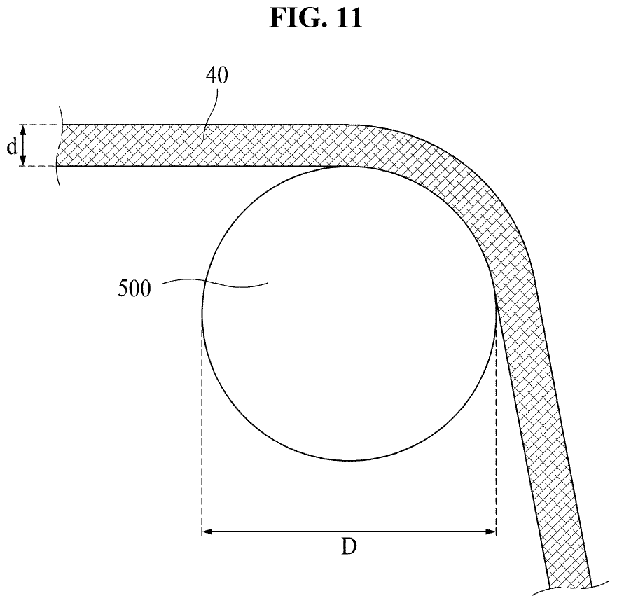

FIG. 10 is a cross-sectional view showing a state in which a chock cover 500 is attached to a chock 530 according to one embodiment of the present invention. FIG. 11 is a cross-sectional view showing the ratio of the diameter of the curvature of a chock 530 and the diameter of a rope 40 according to one embodiment of the present invention.

Referring to FIGS. 10 and 11, the chock cover 500 on a vessel according to one embodiment of the present invention is fastened to the inner surface of the chock 530, a rope 40 comes into contact with the outer surface of the chock cover 500, and the chock 530 and the chock cover 530 have a predetermined curvature along the arrangement direction of the rope 40 as shown in FIGS. 10 and 11. The chock cover 500 is composed of a hollow composite material 510 whose outer surface contacts the rope 40 and a rubber member 520 attached to at least a portion of the inner surface of the composite material 510 and contacting the outer surface of the chock 530. The outer surface of the rubber member 520 has a shape corresponding to the inner surface of the composite material 510, and the inner surface of the rubber member 520 has a shape corresponding to the outer surface of the chock 530, and the chock cover 500 may be mainly cylindrical or may have an oval shape along the penetrating direction.

The composite material 510 above includes a front portion 500a facing the outside of the vessel and a rear portion 500b facing the vessel, and the curvature radius of the rubber member 520 increases toward the front portion 500a. For example, as shown in FIG. 10, the length of the front portion 500a (b) of the chock cover 500 is formed longer than the length of the rear portion 500b (a) of the chock cover 500. This increases the curvature radius of the rubber member 520, thereby increasing the curvature radius of the chock cover front portion 500a, and thus alleviates the phenomenon of the rope 40 being sharply bent at the front portion 500a of the chock cover 500, thereby preventing a decrease in the performance and shortened life of the rope 40. In that case, the ratio D/d of the diameter (d) of the rope 40 and the curvature diameter D of the chock cover 500 is preferably larger and is formed to be at least 15 or more, and in the above range, the strength and working life of the rope 40 can be maximized. The diameter D of the chock cover 500 refers, precisely, to the diameter of the composite material 510, and more precisely, to the diameter of the front portion 500a of the chock cover 500. In addition, the chock 530 made of cast steel has an uneven surface due to the nature of cast steel. By attaching a rubber member 520 to the inner surface of the composite material 510 and the outer surface of the chock 530 and thus utilizing the elasticity of the rubber member 520, the load from the rope 40 acting on the composite material can be dispersed. The rubber member 520 may be made of CR, FKM, FPM, IIR, etc., and in one embodiment of the present invention, CR, which has excellent weather resistance, oil resistance, flame retardancy, and ozone resistance, was used.

Meanwhile, the composite material 510 may be formed by laminating two or more different prepregs formed by impregnating a resin containing one or more of epoxy, phenol and high-density polyethylene (HDPE) into a fiber containing one or more of glass, carbon and aramid fibers. The prepregs can be composed of a single fiber resin composite material and a mixed fiber resin composite material 510, and can have different lamination angles and repetition numbers of laminations in consideration of strength, rigidity, and various other characteristics, and in order to make the thermal expansion rate uniform and reduce surface roughness during lamination to reduce friction with the rope 40, the prepreg with the thinnest thickness can be laminated on the uppermost layer that comes into contact with the rope 40. In addition, it is preferable that the prepreg laminated on the uppermost layer uses carbon and aramid fibers that are resistant to ultraviolet wear.

When the rubber member 520 with an increased curvature radius of the front portion 500a is attached and formed on the inner surface of the composite material 510, since it is possible to prevent problems of increased manufacturing cost and weight when manufacturing composite material 510 as a single body without rubber member 520 and to prevent the phenomenon of the prepreg in the increased portion being delaminated when a high load is applied to the composite material 510, it is preferable to manufacture the composite material 510 with a uniform thickness and thus prevent interfacial lamination delamination, and to attach and form the front portion 500a and rear portion 500b of the rubber member 520 on the inner surface of the composite material 510 with different thicknesses.

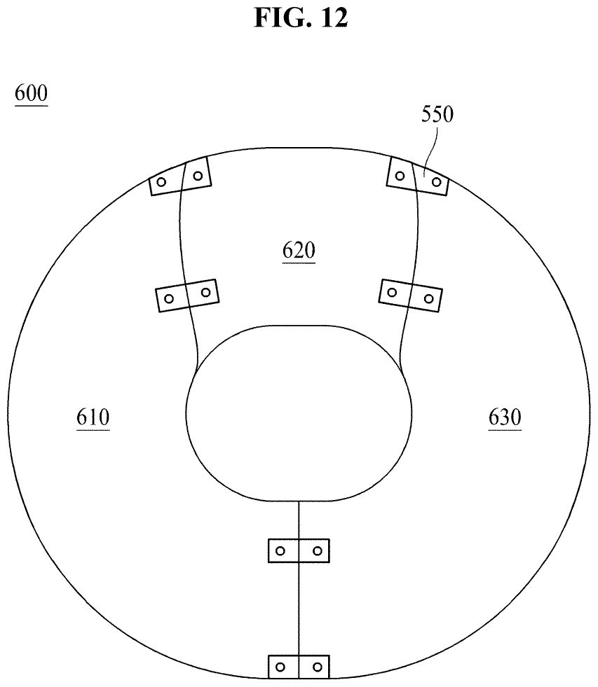

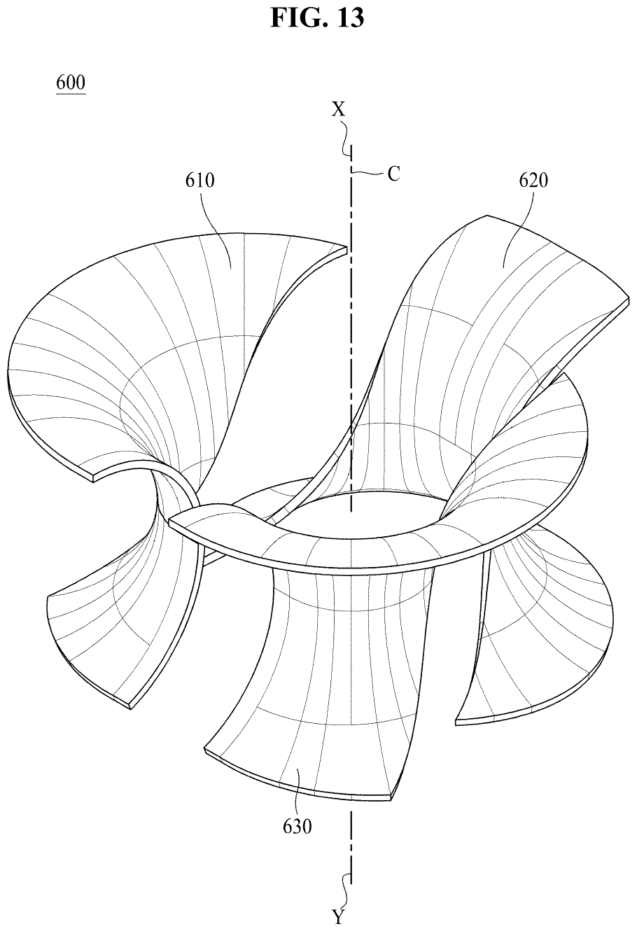

FIG. 12 illustrates a front portion 500a of a three-part chock cover 600 according to one embodiment of the present invention. In one embodiment of the present invention, the composite material 510 is composed of first to third pieces 610, 620, 630, and the connecting portions 540 of the first to third pieces 610, 620, 630 are installed at regular intervals to further strengthen the connection of each composite material 510. FIG. 16 and FIG. 18 illustrate two or more metal plates 550 being installed at a distance from each other.

In the composite material 510, along the central axis C formed in the diameter direction and the vertical direction of the circular or oval hollow portion through which the rope 40 passes in the configuration of the chock cover 500, the first and third pieces 610, 630 may have a shape that is wide at the top and narrow at the bottom in the direction of the front portion 500a, and the second piece 620 may have a shape that is narrow at the top and wide at the bottom, and the first to third pieces 610, 620, 630 may have a tapered shape in which the front in the X direction is wide along the central axis C and the back in the Y direction is narrow. Since the first to third pieces 610, 620, 630 are formed with different widths at the front and back with a predetermined curvature, thereby having a structure in which they are intertwined with each other, when the load of the rope 40 is applied to some composite material 510, the force is distributed to the remaining pieces 610, 620, 630 due to the structure in which the pieces receive force from each other. This divides the width of the first to third pieces 610, 620, 630 into three equal parts with the same size in the front and back, thereby preventing the load of the rope 40 from being concentrated on only some pieces, and thus preventing problems such as deterioration of a specific piece and easy occurrence of cracks in the joint between the pieces.

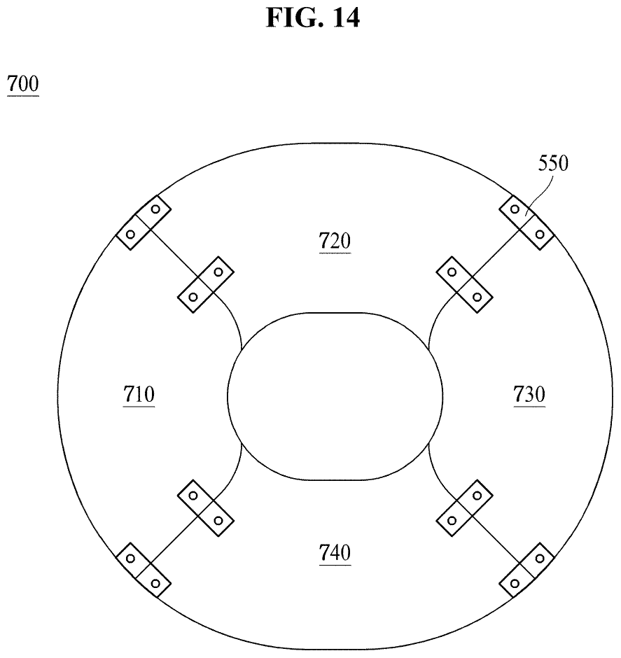

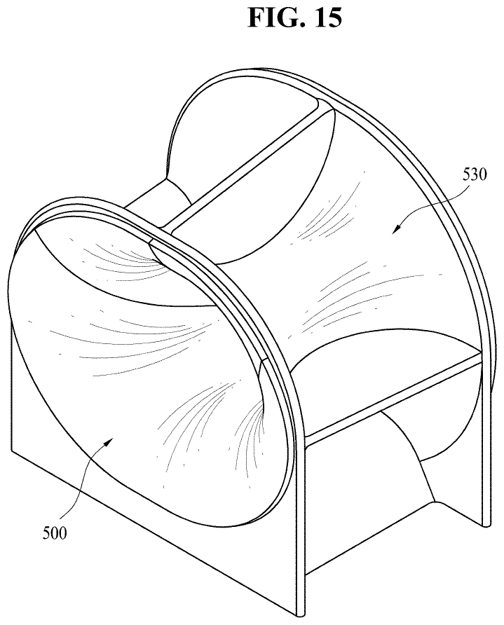

FIG. 14 illustrates the front portion 500a of a four-part chock cover 700 related to one embodiment of the present invention. The same principle as the three-part chock cover 600 is applied so that the load of the rope 40 applied to some pieces having different widths at the front and back with a certain curvature is evenly transmitted to the remaining pieces, and they play a role in holding and supporting each other, thereby adding sturdiness.

In addition, a dye may be added to the resin to color the pieces of the 3- or 4-part composite material 600, 700, and it is preferable to use a coloring agent such as a pigment that does not affect the properties of the resin during curing, and when curing, it is desirable to use a coloring agent such as a pigment that does not affect the properties of the resin, and in order to distinguish each composite material 600, 700, for example, in the case of a four-part composite material 700, the facing pieces can be made in the same color, and the pieces that touch each other can be manufactured in different colors. In order to easily distinguish multiple chocks 530 inside the vessel, they can also be made in various colors.

The detailed description set forth above should not be construed in any way as restrictive but rather as illustrative. The scope of the invention should be determined by a reasonable interpretation of the appended claims, and all changes coming within the equivalency range of the invention are intended to be embraced therein.

### INDUSTRIAL APPLICABILITY

One embodiment of the present invention can be used in a chock cover and a method for manufacturing the same that minimize damage caused by friction of a rope.

1. A chock cover on a vessel, which is formed by laminating two or more different prepregs formed by impregnating a resin containing one or more of epoxy, phenol and high density polyethylene (HDPE) into a fiber containing one or more of glass, carbon and aramid fibers, and
is bent outwardly with a predetermined curvature along an inner central axis, wherein the laminated prepregs are divided formed into three or more pieces.

2. The chock cover on a vessel according to claim 1, wherein the chock cover is divided and formed into three pieces, first to third pieces, while wrapping the chock, and the first to third pieces have a width that varies along an inner central axis of the chock cover.

3. The chock cover on a vessel according to claim 1, wherein the chock cover is divided and formed into four pieces, first to fourth pieces, while wrapping the chock, and the first and second pieces are formed to face with the third and fourth pieces, respectively, and their widths change.

4. The chock cover on a vessel according to claim 3, wherein the first and second pieces are symmetrical with the third and fourth pieces about an inner central axis of the chock cover, respectively.

5. The chock cover on a vessel according to claim 4, wherein the first and third pieces are of a shape that is narrow at the top and wide at the bottom, and the second and fourth pieces are of a shape that is wide at the top and narrow at the bottom.

6. A method for manufacturing a chock cover that protects a rope secured and guided by a chock on a vessel from the chock, the method comprising the steps of:
(a) impregnating fibers with a resin to form a first prepreg;
(b) impregnating fibers with a resin to form a second prepreg;
(c) laminating the first prepreg and the second prepreg;
(d) molding the laminated prepregs in an oven and an autoclave,
wherein the first prepreg and the second prepreg are different from each other in at least one of the components, contents and thicknesses, and
wherein the prepreg includes a fiber base including at least one of glass, carbon and aramid fibers, and a resin containing at least one of epoxy, phenol and high-density polyethylene (HDPE).

7. The method for manufacturing a chock cover on a vessel according to claim 6, wherein the molding step includes the steps of:
removing volatile components from the laminated prepregs in a vacuum bag;
heating the prepregs in an oven and autoclave at 100 to 180° C; and
applying a pressure of 1 to 7 bar while heating in the autoclave.

8. The method for manufacturing a chock cover on a vessel according to claim 6, wherein after making the first and second prepregs, a step of mixing an additive is further included, and the additive is at least one of carbon nanotubes and graphite, and is added in an amount of 0.1 to 5 wt. %.

9. The method for manufacturing a chock cover on a vessel according to claim 6, wherein the prepregs may be composed of three or more layers, and when the prepreg contains only one fiber, the lamination is performed in an order in which the thickness gradually decreases from the lower layer to the upper layer.

10. The method for manufacturing a chock cover on a vessel according to claim 6, wherein the prepregs may be composed of three or more layers, and when the prepregs contain two or more fibers, the prepregs are laminated so that thinner prepregs are located at the bottom and top layers, and thicker prepregs are located inside.

11. A chock cover on a vessel, comprising:
a hollow composite material having an outer surface in contact with a rope; and
a rubber member attached to at least a portion of the inner surface of the composite material and in contact with the outer surface of the chock.

12. The chock cover on a vessel according to claim 11, wherein the composite material includes a front portion facing the outside of the vessel and a rear portion facing the vessel, and the curvature radius of the rubber member increases toward the front portion.

13. The chock cover on a vessel according to claim 12, wherein the ratio D/d of the diameter (d) of the rope to the diameter (D) of the chock cover is 15 or more.

14. The chock cover on a vessel according to claim 11, wherein the composite material is formed by laminating two or more different prepregs formed by impregnating a resin containing one or more of epoxy, phenol and high density polyethylene (HDPE) into a fiber containing one or more of glass, carbon and aramid fibers, and is bent outwardly with a predetermined curvature along an inner central axis.

15. The chock cover on a vessel according to claim 11, wherein the composite material is divided and formed into three pieces, first to third pieces, while wrapping the chock, and the first to third pieces have a width that varies along an inner central axis of the chock cover.

16. The chock cover on a vessel according to claim 11, wherein the composite material is divided and formed into four pieces, first to fourth pieces, while wrapping the chock, and the first to fourth pieces have a width that varies along an inner central axis of the chock cover.
